(19) United States
(12) Patent Application Publication
(10) Pub. No.: US 2020/0226948 A1
(43) Pub. Date: Jul. 16, 2020

(54) Time and Attention Evaluation System

(71) Applicant: Robert Warren, (US)

(72) Inventors: Robert Lee Warren, Salt Lake City, UT (US); Ryan John Hagge, Lehi, UT (US); Scott Marsden Jones, South Jordan, UT (US)

(73) Assignee: Robert Warren, Salt Lake CIty, UT (US)

(21) Appl. No.: 16/247,526

(22) Filed: Jan. 14, 2019

(51) Int. Cl. G09B 19/00

(52) U.S. Cl. CPC G09B 19/00

(57) ABSTRACT

A novel system for evaluating a user's time and attention for the purposes of attributing value to the time and attention and assisting people to understand how their time and attention is being used or wasted. Further, this invention provides users with useful information for setting and attaining goals and comparison to others. The use of this invention enables individuals and organizations because of its novel features and implementations.

This application claims the benefit of U.S. Provisional Application No. 62/617,593, entitled “Time and Attention Evaluation System,” filed Jan. 15, 2018, the contents of which are hereby incorporated by reference.

### BACKGROUND OF INVENTION

Time and attention are important factors in many respects. Time is an asset that cannot be recovered once it has passed. This is particularly the case when specific tasks are to be completed. Attention is the ability to focus on something or someone in order to accomplish a goal, whether that includes understanding what someone may be saying or working on a task.

While time and attention are well understood with respect to their nature and the respective importance of each, it is the combination of the two that make time and attention inherently valuable. The challenge for many people is to have a reliable and consistent metric for evaluating time and attention, and how attention varies over time, in order to attribute some value.

Technology that is readily available to nearly all people provides remarkable access to information, entertainment and other resources, but metrics to measure attention remain relatively crude. Standard time management systems may provide a calendar to help schedule and account for time, and some more advanced systems allow for attributing a measure of productivity to activities that are ostensibly worthy of time (especially at a workplace), but they are coarse measures. This invention provides a more specific series of techniques to evaluate and consider how time is spent and the attention applied to and during specific activities.

Considering attention on a continuum, it is difficult to maintain attention for more than a few minutes. Historically, according to studies, about twelve minutes was the limit of a standard attention span. With professional training and practice, the attention span can be repeated sequentially or lengthened significantly. Similarly, with sufficient and repeated stimuli, interruptions, or distractions the attention span may be shortened.

Some studies claim that the human attention span is now closer to five minutes—less than half of the previous standard. This change may be attributed to many factors, but the increasingly ubiquitous digital technology is a major contributor to the dropping attention span. This is particularly true when you consider smartphones in combination with computers, televisions and other sources of distraction.

When considering attention, it is not only the immediate distraction that is an issue, but the after-effect of the distraction. Were the distraction simply an impulse—that is, a fast onset and similarly fast dissipation—events could be considered discretely. In this case, events and their impact would simply be a result of counting interruptions and evaluating them as a percentage of the total time of an event. This is a technique that some people use in considering time management applications. However, this technique neglects the substantial research that suggests it can take as long as twenty minutes to regain full attention.

This invention considers attention in a much finer detail. Further, this invention considers the impact of interruptions as much more than an impulse, including a residual effect between interruptions.

### SUMMARY OF THE INVENTION

The invention described provides a novel system for evaluating a person's or group of people's time and attention over a period of time. In particular, this invention will apply mathematical analysis techniques in a manner that will render the information valuable, easy to understand, and sufficiently insightful to enable action to be taken based on the supplied information.

In addition to the preferred embodiment, several alternatives are described. Additionally, enhancements are considered.

### DETAILED DESCRIPTION OF THE INVENTION

This invention considers attention in a much finer detail than other methods currently available. Further, this invention considers the impact of a distraction as much more than an impulse, including a residual effect, and interactions between distractions.

For the purpose of this invention, a distraction is any event that may interfere with an activity. A simple example is receiving a message during a study session. Importantly, interruptions may come in any form and through a medium that is not the same as the event itself. For example, one may be listening to a lecture and hear a door slam in the same room or receive a text message on their own personal smartphone. Both cases are distractions and impactful in spite of the fact that they are very different in forms.

Distractions are more than a strict impulse function and actually have a response to the impulse. As a simple comparison, they have a ripple effect not dissimilar to throwing a rock into a body of still water. Eventually, the ripples subside but for some time they are real and visible.

Some researchers, including Earl Miller, PhD, of MIT, claim the ability to get back on task and focus can take upwards of fifteen to twenty minutes. Consider, for example, a one hour class during which a student receives one or more messages—the loss of focus can consume most of the class period. Thus, a distraction can consume a significant portion of an event.

The novelty of this invention is to consider those interruptions on their own merits, with some attribution to the type of distraction, source of the distraction, in context of the event with which the distraction is interfering and in relation to other interruptions. This consideration enables a new means of measuring the impact of one or more distractions and to convey the impact of the interruptions over a period. Further, it enables distractions to be evaluated differently based on the nature of the distraction. For example, a message received from a supervisor during work hours will not necessarily be considered to have the same impact as a personal message received during the same work hours.

In the preferred embodiment, a period of interest (POI) is considered. A POI may be a convenient period, such as a workday, study period, or such. In this invention, a POI is divided into short time segments, or subperiods. These subperiod lengths are selected to provide for a reasonable resolution of time. For the purposes of this description, subperiods are five minutes in length. It will be clear to the reader that other lengths are possible and may suit specific situations.

These subperiods are then evaluated in terms of their attention level. This evaluation is based on the amount of time spent on a task versus the amount of time taken by interruptions. To the degree the subperiod is spent on the task to be accomplished, the subperiod has a value of complete attention. For example, complete attention is 100%, or a value of 1. Any scaled value may be used and the actual attention level may be less than 100%.

A distraction may take a number of forms, including that of an impulse as described above, but in the preferred embodiment single interruptions are considered to have the characteristics of an immediate rise and then a decay over a short period. Based on research, including that of Earl Miller, the more critical period of a distraction is the first sixty-four (64) seconds after the onset of the distraction. For the preferred embodiment, a distraction decays over a period of sixty (60) seconds. In the preferred embodiment, the decay is approximated with an exponential decay so that the initial seconds of the impact of the distraction carries the greatest value. The decay may be approximated in any number of ways, and may vary based on type of distraction, context, frequency, or other factors.

In the preferred embodiment, the value of the distraction is the portion of the period of interest as a percentage. For example, a distraction that has a sixty (60) second decay will be responsible for about 15% of the entire example subperiod based on a simple exponential decay. During a subperiod with a single distraction as just described, the total value of the subperiod is 0.85 (1-0.15) or 85%. Importantly, the value attributed to a distraction may be considered as other than a percentage. This may include a scale, as one might consider using the Richter scale for seismic events or the volume setting on an entertainment console, a token system, or other measurement means. The scale may also vary based on the context, source, or type of distraction.

It is important to understand that if multiple interruptions occur, the effects can be more than simply attributing a single distraction. For example, a distraction, after the initial impact, may be ignored and have little effect; however, if a distraction generates a response, as in the case of a text message or email, the impact of the distraction is far greater. Moreover, if a series of interruptions occur within a short period, one may reasonably assume that the distracted party's attention was never released from the first and subsequent interruptions.

For the preferred embodiment, if two interruptions occur within a single subperiod, sequence of subperiods, or five minutes or less within the same medium, the entire subperiod is valued as fully distracted. In other words, the subperiod value will be considered to be 0%. The period over which multiple interruptions are considered to have a cumulative effect can vary based on time, context, source of distraction, or other factors.

Over the POI, subperiod values are accumulated. In one embodiment, these can simply be considered individually; however, in the preferred embodiment subperiods are considered in light of subsequent subperiods over the POI. That is, the effect of a distraction will not necessarily disappear after a single subperiod. This is ideally accomplished by using a moving average process, whereby an average value of subperiods is considered over a moving window of a number of subperiods. The number of subperiods used to calculate the moving average may vary based on a number of factors, including, but not limited to, type of user, time of day, activities being evaluated, context and other factors.

POIs or subperiods may also be evaluated over longer periods, or timeframes, including over days or even longer periods. For example, a POI of 9 am to noon with subperiods of five minute durations may be evaluated over the period of a week or more on a POI or subperiod-by-subperiod basis. This may provide insights into repetitive patterns or other information. In the preferred embodiment, these multi-period evaluations will also utilize a moving average means of evaluating value over time.

The application of moving averages to rapidly changing values provides a more useful and meaningful view of attention values by virtue of the fact that it highlights interruptions and the impact of those interruptions. Using a moving average is used often in financial sectors. Technical traders on various stock markets rely on moving averages to provide signals for buying or selling stocks. Moving averages can take many forms, including standard, weighted, exponential, and others, to best match the goal. Some used more sophisticated moving averages, including combination moving averages, in order to fit their needs.

In a similar manner, the novel application of moving averages to the value of attention over time can vary greatly. The variations may include averaging period, the use of multiple moving averages and other variations, and may be a result of specific types of users, contexts, including activities at the moment, different day types, e.g., school days versus workdays versus weekends or holidays.

In the preferred embodiment, the value of attention is readily visible by a user. This may be in the form of a number on a scale or a visual graph. The use of a graph provides the benefit of showing a given value relative to other scores. In both cases, and others, including combinations, a value or set of values may be considered against historical, aggregate or a target value or set of values.

In the preferred embodiment of this invention, information from multiple users is aggregated to provide a composite attention profile. This profile will vary based on type of user and context, but may be used for a variety of applications, including providing a guide to interpret information from any particular user or group of users. Moreover, the aggregated information may be used to look for specific trends over time and across wide user bases. Additionally, the aggregated information will be useful for machine learning applications to gain unforeseen insights.

The evaluation and measurement of attention is novel in its own right, but a key advantage of this invention as described is the ability to monitor ones attention over a period in a manner that allows for short-term insights as well as an overall, long-term picture of attention.

### Example

The invention disclosed herein is novel in several respects. The example to follow provides a preferred embodiment incorporating novel features of the invention.

A school day of a typical student is monitored using this invention. Periods during class are assumed to provide a nominal level of attention if the time is without distraction. An undistracted class period is given a 100% attention level. The attention may actually be less than 100%, and that may be determined through various means.

Throughout the school day, some class periods are without distraction and given a 100% score. One class includes a text message on the student's smartphone, but there was no response. This yields a subperiod score of 85%. Based on a moving average over ten (10) subperiods, this single distraction will show an effect of at least four (4) subperiods, or about twenty (20) minutes total. In other classes several back-and-forth emails between the student and others occur and, based on the system's evaluation, the specific subperiods have a value of 0%. Over the longer period used for the moving average, the overall value is less than 50%. Passing periods between classes and lunch see a high degree of distraction from various sources.

The invention here not only calculates the subperiod-to-subperiod values over the course of the school day, but also looks for patterns over several days. Using these patterns, which may be discerned by machine learning techniques or other techniques, the system is able to discern periods that should not be considered. In this example, for instance, the periods between classes should not have any impact on actual class time.

The student is able to see the value as it varies throughout the day and can see how these values compare to goals that had been set and what the trends are during specific times of a day or longer period.

What is claimed is:

1. A system to evaluate time and attention and the impact of interference events.

2. The time and attention evaluation system of claim 1 that evaluates impact of interference events based on one or more factors.

3. A factor of claim 2 that includes at least one of the immediate impact of the interference event or the impact residual of the interference event.

4. The impact residual of claim 3 that is considered as decay from immediate impact to zero.

5. The impact residual of claim 4 that is based on an exponential decay.

6. The time and attention evaluation system of claim 1 that evaluates over a specific period.

7. The specific period of claim 6 that is divided into subperiods.

8. A subperiod of claim 7 that can vary based on at least one of time of day, day of week, anticipated activity, or other factor.

9. A subperiod of claim 7 that is approximately 5 minutes in length

10. The time and attention evaluation system of claim 1 that evaluates attention level over at least one subperiod.

11. The time and attention evaluation system of claim 1 in which time over a plurality of subperiods is evaluated using a time series function to provide evaluation over multiple subperiods.

12. The attention level evaluation of claim 7 in which the attention is considered as a unit for each subperiod.

13. The attention level evaluation of claim 7 that determines the percentage of the subperiod affected by the impact of the interference event.

14. The attention evaluation level of claim 7 in which full attention is considered 100% of the unit and in which no attention during subperiod is considered 0% of the unit.

15. The attention evaluation level of claim 7 that is scaled to provide at least one of a quantitative value or qualitative value.

16. The time and attention evaluation system of claim 1 that evaluates the impact of an interference event on the context of the event.

17. The context of claim 16 that includes at least on of time of day, day or week, type of interference event, or source of interference event.

18. The time and attention evaluation system of claim 1 that evaluates the impact of an interference event on reaction to the interference event.

19. The reaction of claim 18 that based on at least one of type or duration of reaction.

20. The time and attention evaluation system of claim 1 that considers multiple interference events within a subperiod of time to be a single event.

21. The time and attention evaluation system of claim 1 that uses machine learning algorithms to discern patterns within impacts of interference events.

22. The time and attention evaluation system of claim 1 that presents the attention evaluation in a human understandable form that is at least one of graphical information or textual information.

23. A system to evaluate time and attention and the impact of interference events based on patterns over timeframes.

24. Timeframes of claim 23 that may be one or more of days, weeks, months, or years.

25. The time and attention evaluation pattern of claim 23 that is smoothed by a time series function.

26. The time series function of claim 25 that varies based on one or more factors.

27. The factors of claim 27 that are based on types of timeframes evaluated.

28. A system to evaluate time and attention that aggregates interference event information from more than one source.

29. The aggregated information of claim 27 that provides a means for comparison.

30. The aggregated information of claim 27 that uses machine learning algorithms to determine specific patterns
